(19) United States
(12) Patent Application Publication
(10) Pub. No.: US 2010/0313454 A1
(43) Pub. Date: Dec. 16, 2010

(54) CABLE LABEL AND METHODS

(75) Inventors: Alton Clayton Smith, JR., Clayton, GA (US); Larry Allen Cook, Woodstock, GA (US)

Correspondence Address: MERCHANT & GOULD PC, P.O. BOX 2903, MINNEAPOLIS, MN, 55402-0903, US

(73) Assignee: ADC Telecommunications, Inc., Eden Prairie, MN (US)

(21) Appl. No.: 12/778,300

(22) Filed: May 12, 2010

Related U.S. Application Data
(60) Provisional application No. 61/177,884, filed on May 13, 2009.

(51) Int. Cl. G09F 3/10; G09F 3/02; B05D 5/00; B32B 37/12

(52) U.S. Cl. 40/316; 40/672; 40/638; 427/256; 156/60

(57) ABSTRACT

The present disclosure provides an improved label and method of manufacturing a label that is of the type that can be folded onto itself over an object to be labeled. The improved label is configured to avoid wrinkles and exposed adhesive portions during use.

### RELATED APPLICATIONS

This application claims priority to provisional application Ser. No. 61/177,884 filed on May 13, 2009, which is incorporated by reference herein in its entirety.

### TECHNICAL FIELD

The present disclosure relates to labels for a cable and methods of making and using the same.

### BACKGROUND

Labels configured to identify a telecommunications cable, patch cord, or other wire-like structure (referred to hereinafter as “cable”) commonly include a flexible body portion with an adhesive surface that is configured to be folded over the cable and back onto itself. Such labels can be relatively cumbersome to use as it is easy to misalign the portions of the label, thereby resulting in wrinkles in the label or adhesive covered portions of the label being exposed.

Referring to FIG. 6, a prior art label 10 is shown attached to a cable 12. Cable 12 is a telecommunications patch cord including an optical fiber cable, and fiber optic connectors on opposite ends of the cable. In the depicted application, the rear portion 14 of the label 10 is misaligned with the front portion 16. The misalignment resulted in adhesive covered portions 18, 20 of the label 10 being exposed and a wrinkle 22 in the text covered portion of the label 10.

Although the depicted exposed adhesive portion of the label 10 may be trimmed away in a separate step, the depicted wrinkle 18 would interfere with the readability of the text on the label and likely requires that the label 10 be entirely cut away and a new one reapplied. Accordingly, improved label configurations are desirable.

### SUMMARY

The present disclosure provides an improved label and method of manufacturing a label that is of the type that can be folded onto itself over an object to be labeled. The improved label is configured to avoid wrinkles and exposed adhesive portions during use.

### BRIEF DESCRIPTION OF THE DRAWINGS

FIG. 1 is a front view of a label according to an embodiment of the present disclosure shown attached to a cable;

FIG. 2 is a rear view of the label of FIG. 1 shown attached to a cable with the first and second portions of the label aligned;

FIG. 3 is a rear view of the label of FIG. 1 shown attached to a cable with the axis of the first and second portions of the label at an angle α relative to each other;

FIG. 4 is a rear view of the label of FIG. 1 before it is attached to a cable;

FIG. 5 is a perspective view of a label before it is separated from a roll of labels;

FIG. 6 is a front view of a prior art label attached to a cable; and

FIG. 7 is a rear view of an alternative embodiment of the label of FIG. 1 before it is attached to a cable.

### DETAILED DESCRIPTION OF THE PREFERRED EMBODIMENT

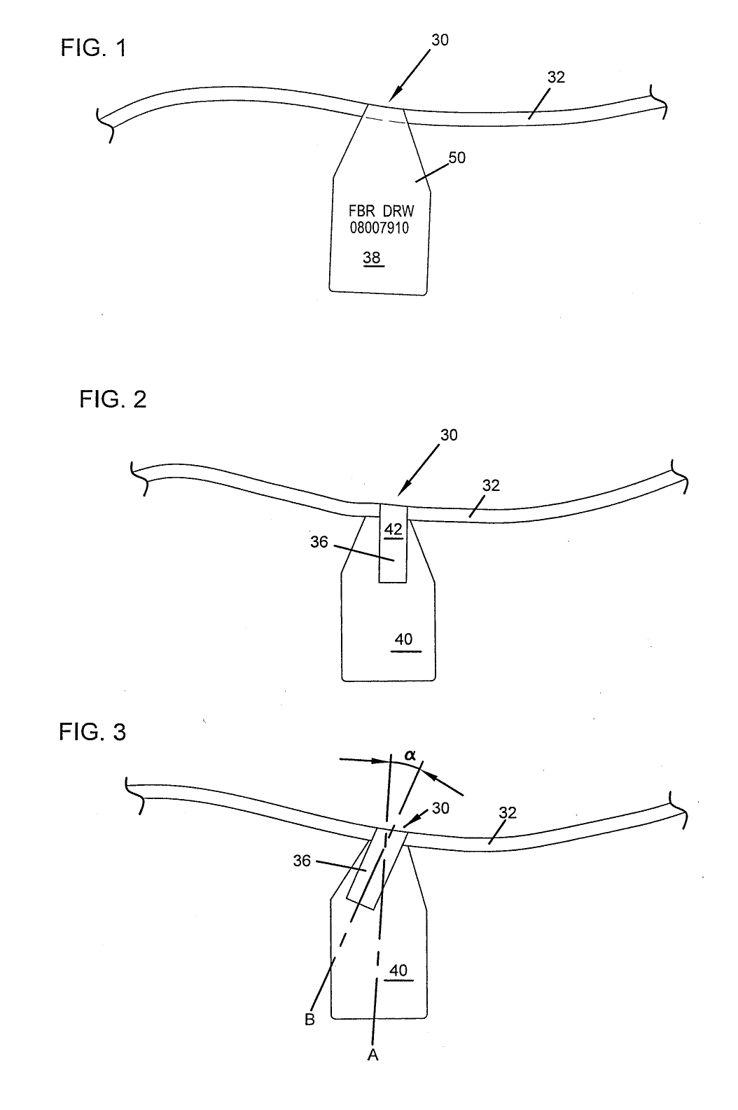

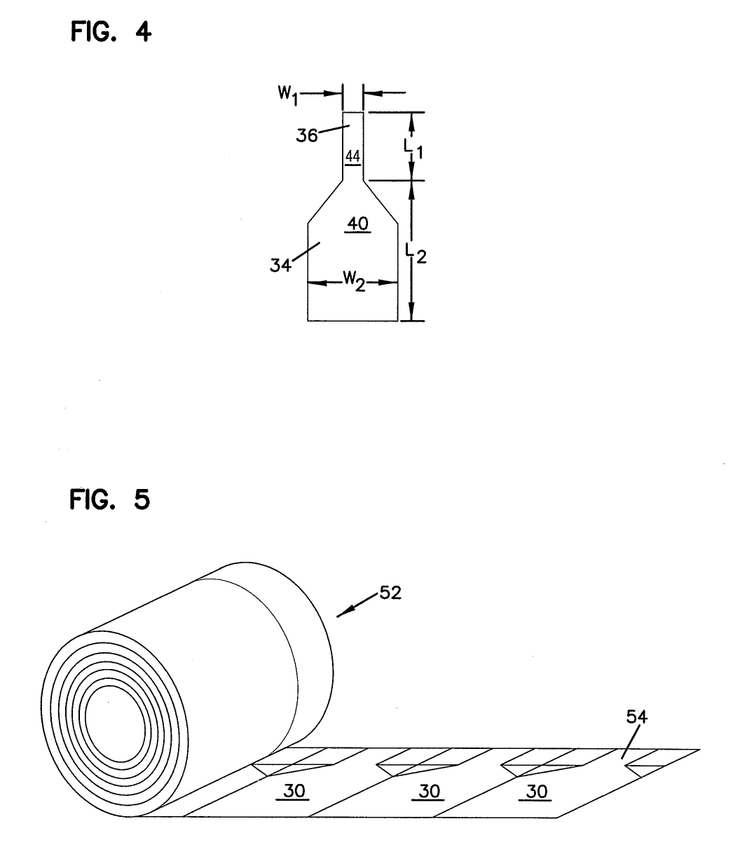

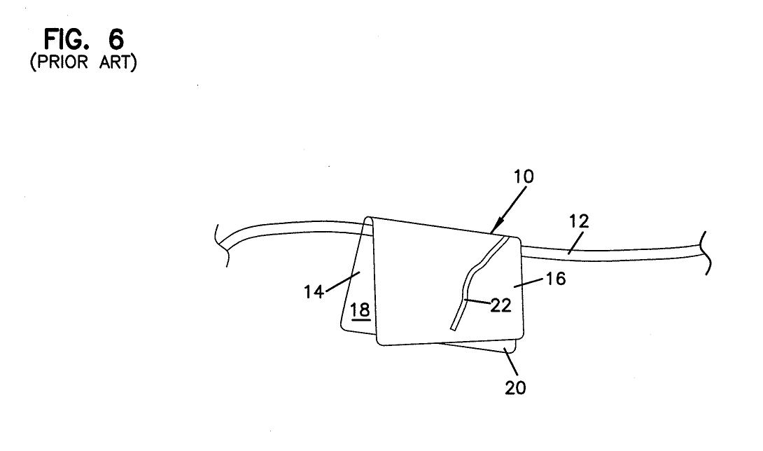

Referring to FIGS. 1-5, an embodiment of a label 30 according to the present disclosure is shown. In the depicted embodiment the label 30 is folded over the cable and connected back onto itself. The label 30 includes a flexible body having a first portion 34 connected to a second portion 36. In the depicted embodiment, the flexible body of the label 30 is constructed from a continuous sheet of material that extends from the first portion 34 to the second portion 36. The flexible sheet of material can be, for example, a polyethylene material.

In the depicted embodiment, the first portion 34 of the label 30 includes a first surface (front surface) 38 and a second surface (back surface) 40. Information about the cable (text 50 and other indicia (e.g., symbols)) can be printed on the first surface 38 of the first portion 34. It should be appreciated that the information can be printed onto the label 30 or otherwise marked to included indicia (e.g., stamped, hand written, etc.) while the labels are on a continuous roll of label material 52, or after the label has be separated into individual labels, or even after the label is attached to the cable.

In the depicted embodiment, the second portion 36 also includes a first surface (front surface) 42 and a second surface (back surface) 44. The second surface 44 of the second portion 36 includes an adhesive material thereon, and first and second surfaces 38, 40 of the first portion 34 do not have adhesive material thereon. In the depicted embodiment the second portion includes a removable non-stick material 54 that covers the adhesive until it is manually peeled away before the label 30 is attached to the cable 32. It should be appreciated that many alternative configurations are also possible that would enable the second surfaces to connect to each other when the label 30 is attached to the cable 32, which is described in greater detail below.

In the depicted embodiment, the first and second portions 34, 36 of the label 30 are configured so that they can be folded around a cable 32 and against each other such that the second surface 44 of the second portion 36 is brought into direct contact with the second surface 40 of the first portion 34. Further, the depicted label 30 is configured such that the first and second portions 34, 36 are configured such that when they are folded against each other the second portion 36 does not extend past the first portion 34. Accordingly the second surface 44 of the second portion 34 is not exposed once the label 30 is attached to the cable 32. As will be discussed in greater detail below, this configuration helps decrease the likelihood that adhesive covered portions of the label remain exposed after the label is attached to the cable.

In the depicted embodiment the second portion 36 is configured to be automatically sufficiently aligned with the first portion 34 such that the adhesive on the second portion 36 is not exposed when the second portion 36 is folded against the first portion 34. In the depicted embodiment the second portion 36 has a longitudinal axis A-A and the first portion 34 has a longitudinal axis B-B. When the angle α is zero, the axes A-A and B-B are completely aligned (see FIG. 2), and when the angle α is not zero the axes A-A and B-B are offset (see FIG. 3). The label 30 of the depicted embodiment is configured so that the angle α between the longitudinal axes A-A and B-B is normally within 0 to 45 degrees (in the plus or minus direction) when applied. Accordingly, the label 30 is configured so that even when the axis is substantially offset (e.g., offset by 45 degrees) the adhesive covered portions of the second portion 36 are not exposed when the second portion 36 is connected to the first portion 34. In the depicted embodiment this advantageous feature is enabled in part by the geometric shape of the portions of the label as well as the relative sizes of different portions of the label.

With respect to the relative size of the portions of the depicted label 30, the first portion 34 has a surface area that is larger than the surface area of the second portion 36. In some embodiments the surface area of the first portion 34 is at least 125 percent greater than the surface area of the second portion 36. In some embodiments the first portion 34 has a surface area that is at least 200 percent greater than the surface area of the second portion 36. In additional embodiments the first portion 34 has a surface area that is at least 300 percent greater than the surface area of the second portion 36. It should be appreciated that many other relative size arrangements are possible. The smaller the second portion 36 is to the first portion 34, the less likely that adhesive covered portions of the second portion 36 will be exposed when the label 30 is attached to the cable 32.

With respect to the shape of the portions of the depicted label 30, the second portion 36 has a width W1 that is less than the width W2 of the first portion 34. For example, W1 could be 0.5 inches and W2 could be 1.0 inch. In addition, the second portion 36 has a length L1 that is less than the length L2 of the first portion 34. For example, L1 could be 1.0 inch and L2 could be 1.5 inches. It should be appreciated that the greater the width of the first portion W2 is to the width of the second portion W1, the less likely that adhesive covered portions of the second portion 36 will be exposed when the label 30 is attached to the cable 32. Likewise, it should be appreciated that the greater the length of the first portion L2 is to the length of the second portion L1, the less likely that adhesive covered portions of the second portion 36 will be exposed when the label 30 is attached to the cable 32.

In the depicted embodiment the first portion is shaped generally like a pentagon and the second portion is shaped like a tapered beam. The configured makes it relatively unlikely that the second portion would be exposed past the first portion even when the first and second portions offset from each other when they are connected. In the depicted embodiment the division between the first and second portions of the label coincides with the zone of the label that is configured to be wrapped around the cable. However, it should be appreciated that the label 30 can be of a variety of different shapes other than what is shown. It should be appreciated that the first portion could be alternatively shape, for example, like a rectangle or circle and the second portion could be shape like a non-tapered beam or a tennis racket.

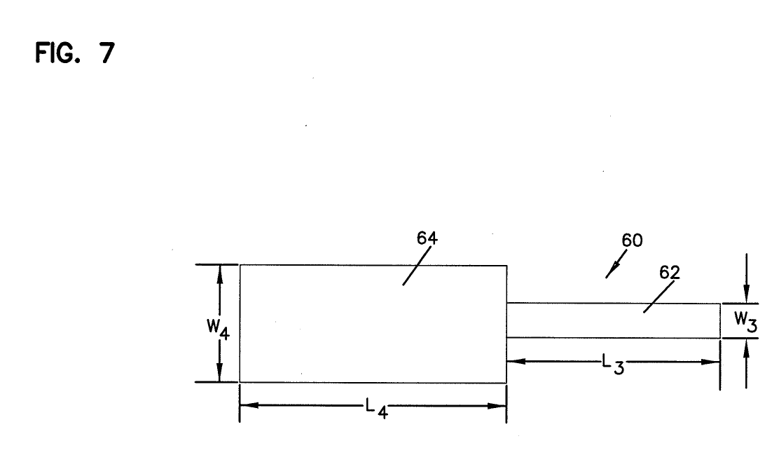

Referring to FIG. 7, an alternative embodiment of the label 30 is shown. Label 60 includes a first portion 64 and second portion 62. The first portion 64 is configured to be labeled (e.g., printed on or otherwise marked to include indicia), and the second portion 62 includes a side that includes adhesive thereon. The first portion 64 is generally rectangular having a width W4 that is about 1.0 inches and a length L4 that is about 2.25 inches. The second portion 62 is also generally rectangular having a width W3 that is about 5/16 of an inch and a length L3 that is about 2.0 inches long. Label 60 of the depicted embodiment has many of the same advantages over the prior art as label 30 of the first disclosed embodiment, which is described in detail above.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A cable label comprising:
a first portion having a first surface and a second surface;
a second portion including a first surface and a second surface;
wherein the first portion and the second portion are connected and configured to fold around a cable and against each other such that the second surface of the second portion is brought into direct contact with the second surface of the first portion;
wherein the first and second portions are configured such that when they are folded against each other the second portion does not extend past the first portion;
wherein the second surface of the second portion includes an adhesive thereon; and
wherein the first and second surfaces of the first portion do not have adhesive thereon.

2. The label of claim 1, wherein the first portion has a surface area and the second portion has a surface area, wherein the surface area of the first portion is at least 125 percent greater than the surface area of the second portion.

3. The label of claim 1, wherein the first portion has a surface area and the second portion has a surface area, wherein the surface area of the first portion is at least 200 percent greater than the surface area of the second portion.

4. The label of claim 1, wherein the first surface of the first portion includes indicia thereon.

5. The label of claim 1, wherein the second portion is configured to be sufficiently aligned with the first portion such that the adhesive on the second portion is not exposed when the second portion is folded against the first portion.

6. The label of claim 1, wherein the second portion has a longitudinal axis and the first portion has a longitudinal axis and the angle between the longitudinal axes of the first and second portions is between 0 to 45 degrees.

7. A label comprising:
a flexible body including a first portion and a second portion that are configured to fold against each other such that the first portion adheres to the second portion;
wherein the first portion has a width that is greater than a width of the second portion.

8. The label of claim 7, wherein the first and second portions are configured such that when they are folded against each other the second portion cannot extend past the first portion.

9. The label of claim 7, wherein the flexible body includes a continuous sheet of material that extends from the first portion to the second portion.

10. The label of claim 7, wherein the first portion has a length that is greater than a length of the second portion.

11. The label of claim 7, wherein the first portion has a surface area and the second portion has a surface area, wherein the surface area of the first portion is at least 125 percent greater than the surface area of the second portion.

12. The label of claim 7, wherein the first portion has a surface area and the second portion has a surface area, wherein the surface area of the first portion is at least 200 percent greater than the surface area of the second portion.

13. The label of claim 12, wherein the second portion includes an adhesive surface.

14. The label of claim 11, wherein the second portion includes a removable non-stick surface covering the adhesive surface.

15. A method of manufacturing a cable label comprising:
applying adhesive on a portion of a label that is configured to fold around a cable and back onto itself;
wherein the portion with the adhesive thereon is sized and arranged so that when the portion is folded onto itself none of the adhesive will be exposed.

16. The method of claim 15, wherein the second portion has a longitudinal axis and the first portion has a longitudinal axis and the label is configured such that the angle between the longitudinal axes of the first and second portions ranges between 0 to 45 degrees.

17. The method of claim 15, wherein the portion that has the adhesive thereon has a surface area which is less that forty-four percent of the total surface area of the label.

18. The method of claim 17, wherein the portion that has adhesive thereon is less than thirty-three percent of the total surface area of the label.

19. The method of claim 15, wherein a portion of the label that does not have adhesive is configured to be directly printed or written on.

20. A method of labeling a cable comprising:
folding a label around a cable wherein the label has first and second portions which face one another when the label is folded around the cable;
adhering the first portion to the second portion with adhesive located on the second portion;
wherein the first portion does not contain any adhesive before the adhering step; and
wherein the first portion has a greater surface area relative to the surface area of the second portion.

21. A labeled cable comprising:
a cable including a body portion extending between a first end and a second end;
a label including:
a first portion having a first surface and a second surface;
a second portion including a first surface and a second surface;
wherein the first and second portions of the label are fold around the body portion of a cable such that the second portion does not extend past the first portion;
wherein the second surface of the second portion includes an adhesive thereon; and
wherein the first and second surfaces of the first portion do not have adhesive thereon.
